(19) United States
(12) Patent Application Publication
(10) Pub. No.: US 2018/0183174 A1
(43) Pub. Date: Jun. 28, 2018

(54) PLUG-IN CONNECTOR

(71) Applicant: Weidmüller Interface GmbH & Co. KG, Detmold (DE)

(72) Inventors: Michael HERRMANN, Detmold (DE); Constantin CLASSEN, Detmold (DE); Karlo STJEPANOVIC, Bielefeld (DE)

(21) Appl. No.: 15/735,385

(22) PCT Filed: Jun. 17, 2016
(86) PCT No.: PCT/EP2016/064061

§ 371 Date: Dec. 11, 2017

(30) Foreign Application Priority Data
Jun. 29, 2015 (DE) 20 2015 103 401.6

(51) Int. Cl. H01R 13/518; H01R 4/2433; H01R 4/48; H01R 13/713

(52) U.S. Cl. CPC H01R 13/518; H01R 13/7137; H01R 4/4818; H01R 4/2433

(57) ABSTRACT

A plug-in connector includes a housing containing at least two chambers into each of which a plug-in contact that can be connected to a conductor is inserted. The plug-in contact is arranged in an insert which includes a conductor receptacle by which the plug-in contact can be connected to a particular conductor without a tool. An insert is inserted into each of the chambers.

### RELATED APPLICATIONS

This application is a § 371 of PCT/EP2016/064061 filed Jun. 17, 2016. PCT/EP2016/064061 claims priority of DE 20 2015103401.6 filed Jun. 29, 2017. The entire contents of these applications are incorporated herein by reference.

### BACKGROUND OF THE INVENTION

The invention relates to a plug-in connector including a housing in which at least two chambers are formed and into each of which a plug-in contact that can be connected with a conductor is inserted.

Such plug-in connectors are used, for example, for connecting controls or input modules and/or output modules of industrial automation systems. At least two, but usually a larger number, of plug-in contacts are provided which are inserted in the housing. The plug-in connectors are often arranged in one or more parallel rows in the housing.

### BRIEF DESCRIPTION OF THE PRIOR ART

In order to, manufacture such a plug-in connector, individual conductors are connected, for example, by a crimping technique to a plug-in contact and these plug-in contacts are inserted into one of the chambers where they engage each other. Furthermore, plug-in connectors of this type are known in which the plug-in contacts are firmly inserted into the chambers. The plug-in contacts include a conductor receptacle in a push-in connection assembly. In such a plug-in contact, a conductor, in particular a conductor with only a small cross section or a conductor with a litzen bundle, can only be inserted if a rigid wire end ferrule was previously crimped onto the conductor.

The known connections of the conductors to the plug-in contacts can only be manufactured in an expensive manner. This is especially true since in industrial automation systems, the conductors coming from sensors and/or actuators are usually installed first and then the plug-in connector must be covered on site in the field with these conductors.

The present invention was developed to solve the problem of creating a plug-in connector of the above-described type which can also be covered in the simplest manner possible on site with the individual conductors.

### SUMMARY OF THE INVENTION

In a plug-in connector according to the invention, the plug-in contacts are arranged in inserts, wherein each insert includes a conductor receptacle by which the plug-in contact can be connected without tools specific to the particular conductor. The inserts can then be inserted into the particular associated chambers. The basic idea is based on the fact that the plug-in contacts are received in the inserts which makes it possible to use a connection technique without tools with the conductor receptacle for the conductor to the plug-in contact. After the connection of the conductor to the plug-in contact, the inserts are inserted into one of the chambers of the housing in which they are preferably fixed by an engagement element or member.

In a preferred embodiment, the conductor receptacle has at least one contact penetrating through the insulation so that an insulating portion of the conductor can be eliminated. The insert preferably includes a subcomponent into which the plug-in contact is inserted and includes an upper part pivotably connected to the lower part. After the conductor is, introduced into an opening of the upper part, the latter can be pivoted on the lower part in such a manner that the inserted conductor is inserted into a section of the plug-in contact which penetrates through the insulation. This insulation-penetrating section of the plug-in contact includes one or more fork-shaped cutting contacts or needle-shaped contacts. The upper and the lower parts are preferably provided with engagement elements so that they engage with one another in a closed pivoting position.

In an alternative embodiment, the conductor receptacle includes a traction spring which is manually compressed for inserting the conductor and produces a contact force between the conductor and the plug-in contact after it is released based on the tension of the spring.

In another embodiment, the plug-in connector includes at least one excess temperature warning element which supplies an optical and/or electrical signal about an excess temperature occurring on one of the inserts. The excess temperature warning element preferably includes an element having a memory metal which deforms during the excess temperature and therefore initiates the signaling of the excess temperature. In this way, contact problems which occur, for example, on one of the plug-in contacts or in the connection between one of the plug-in contacts and an introduced conductor, can be recognized before a dangerous (fire) situation occurs.

### BRIEF DESCRIPTION OF THE FIGURES

The invention is explained in detail in the following specification when viewed in the light of the accompanying drawing, in which:

FIG. 1 is a perspective view of a plug-in connector with inserts;

FIG. 2 is a detailed perspective view of an insert of the plug-in connector of FIG. 1 in an open condition before the connection to a conductor;

FIG. 3 is a perspective view of the insert from FIG. 2 in a closed condition with a connected conductor;

FIG. 4 is a perspective view an insert for a plug-in connector according to another embodiment;

FIG. 5 is a perspective view of another exemplary embodiment of a plugin-connector with excess temperature warning elements;

FIG. 6 is a perspective view of the plug-in connector of FIG. 5 with a housing that is represented partially transparently;

FIG. 7 is an isometric view of several warning elements; and

FIG. 8 is an isometric view of the warning elements of FIG. 7 with a released excess temperature warning element.

### DETAILED DESCRIPTION

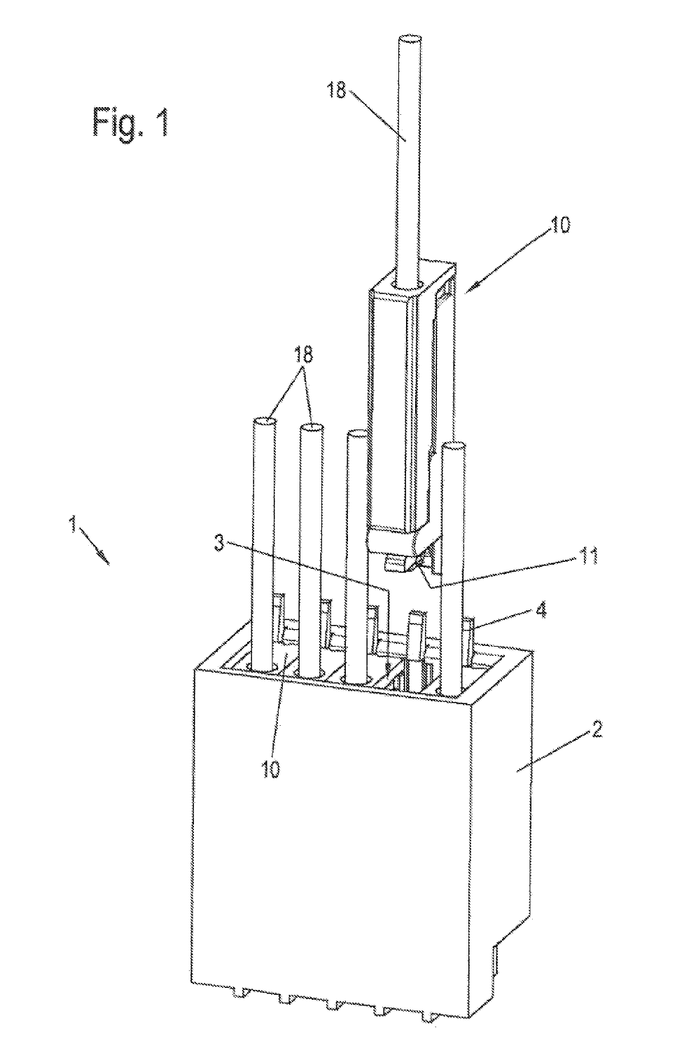

FIG. 1 shows a plug-in connector 1 in a first exemplary embodiment in an isometric view.

The plug-in connector 1 includes a housing 2 in which a plurality of adjacent chambers 3 are formed. In the present instance, five adjacent chambers 3 arranged in a row are present by way of example. It is understood that a plug-connector 1 in accordance with the invention can also be constructed with a larger number of chambers 3 which can be arranged in one or more adjacent rows.

Inserts 10 are inserted into the chambers 3. The inserts include a plug-in contact 11, constructed for example as a tulip contact, on their lower ends in the view of FIG. 1. The plug-in contacts 11 constitute the contacts of the plug-in connector 1 which establish and electrical contact when cooperating with a corresponding counter-plug-in connector between plug-in connector 1 and the counter-plug-in connector.

By way of example, in FIG. 1, inserts 10 are already inserted in four of the five chambers 3. In the inserted state, the inserts 10 engage in the housing 2 by engagement or contact devices 4 constructed on the housing 2. A fifth insert 10 is located outside of the associated chamber 3 into which it can be pushed in the condition as shown.

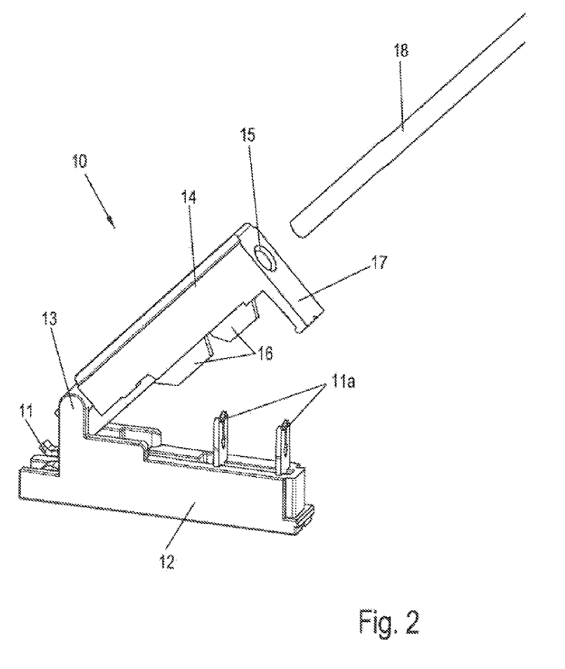

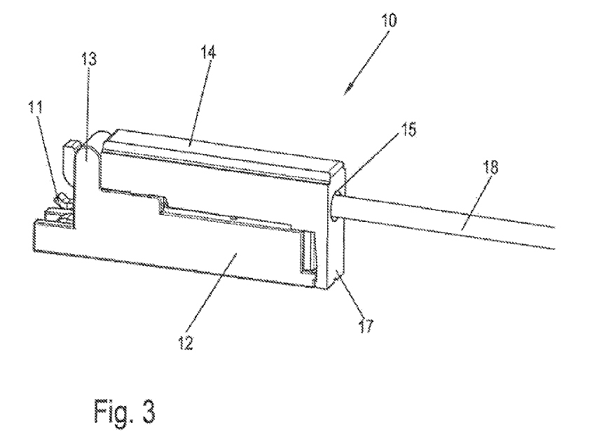

FIGS. 2 and 3 show one of the inserts 10 from FIG. 1 in more detail.

The insert 10 includes a bottom part 12 which is pivotably connected by a pivot assembly 13 to an upper part 14. FIG. 2 shows the insert 10 in an open state in which the upper part 14 has been pivoted up opposite the lower part 12.

The lower part 12 receives the plug-in contact 11 which is preferably constructed in one piece as a stamped bending part from an elastic contact material sheet. The plug-in contact 11 can be inserted into the lower part 12. In particular, the contact can be clipped into or also partially extrusion-coated by the bottom part 12. In addition to the contact section projecting in the view of FIGS. 2 and 3 to the left out of the bottom part 12, the plug-in contact 11 includes a section with two cutting forks or contacts 11a in the present instance. The latter extend in the direction of the upper part 14 out of the bottom part 12.

The upper part 14 includes a conductor opening 15 into which a conductor 18 can be inserted. After the insertion of the conductor 18 into the conductor opening 15, the conductor is run by conductor guides 16 preferably integrally formed on and within the upper part 14.

The insert 10 is closed with the conductor 18 within the opening 15 by pivoting the upper part 14 onto the lower part 12. At this time the conductor 18 is pressed into the cutting forks 11a. The latter are constructed as insulation-penetrating contacts and sever an insulation layer surrounding the conductor 18 so that a core of the conductor 18 is electrically connected to the plug-in contact 11. A catch tongue 17 is formed on the upper part 14 which cooperates with an associated catch projection of the bottom part 12 and holds the insert 10 in the closed state. This closed state is shown in FIG. 3.

The conductor 18 can therefore be connected to the plug-in contact 11 without tools or further preparation. The bottom part 12 and the upper part 14 of the insert 10 are preferably dimensioned in such a manner that they can be readily grasped between the fingers and compressed. In the state shown in FIG. 3, the insert 10 can then also be inserted into one of the chambers 3 of the housing 2 of the plug-in connector 1 without tools, as is shown in FIG. 1.

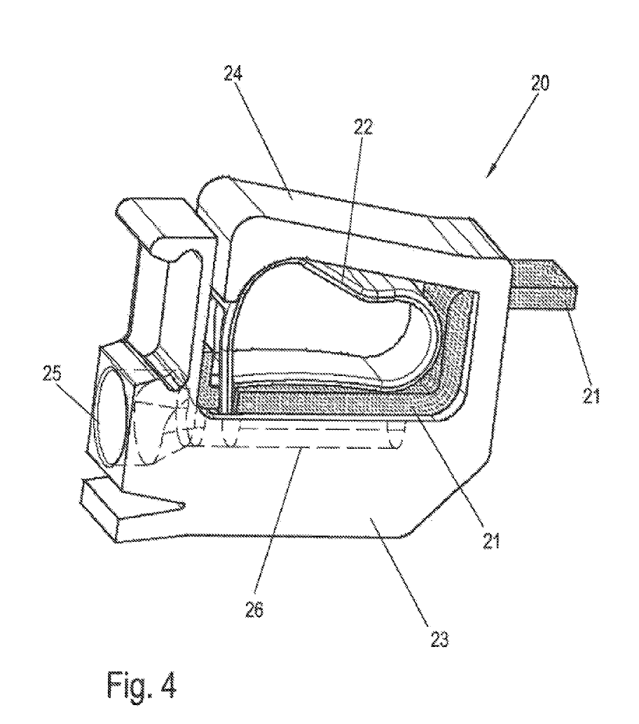

FIG. 4 shows another embodiment of an insert 20 for a plug-in connector. The insert 20 shown in FIG. 4 can be inserted into the chambers of a plug-in connector in a manner comparable to that of insert 10, wherein a suitable plug-in connector can be constructed comparable to the plug-in connector 1 in FIG. 1 and differs only in its dimension and the proportions of the chambers 3.

The insert 20 includes a plug-in contact 21 which is constructed in this example as a flat contact. The plug-in contact 21 projecting to the right in FIG. 4 represents the contact of the plug-in connector.

The insert 20 includes a formed part 23 which is constructed in one piece and includes an elastic section 24. The elastic section 24 is constructed as a free-standing arm which encompasses an open area. A section of the plug-in connector 21 extends into this open area. Furthermore, a traction spring 22 is inserted into this open area and is preferably connected to the plug-in connector. The traction spring 22 has an opening through which a free end of the plug-in contact 21 extends. A bar of the traction spring 22 limiting the opening rests on the bottom of the corresponding section of the plug-connector 21. When pressure is applied to the elastic section 24, the traction spring is compressed so that the bar of the traction spring 22 moves down away from the plug-in contact 21 in the view of FIG. 4.

In this area, a conduit that is open on at least one side and forms a conductor opening 25 and a conductor guide 26 is formed in the formed part 23. When the elastic section 24 is pressed in, a conductor which was previously stripped of insulation can be inserted into the conductor opening 15. The conductor is pressed in the area of the conductor guide 26 after the elastic section 24 has been let go by the bar of the traction spring 22 onto the section of the plug-in contact 21 located inside the formed part 23.

Therefore, up to stripping of the insulation, a conductor can also be connected without a tool to the plug-in contact 21 of the insert 20. The insert can then be inserted, again preferably in an engaging manner, into a chamber of a housing of a plug-in connector.

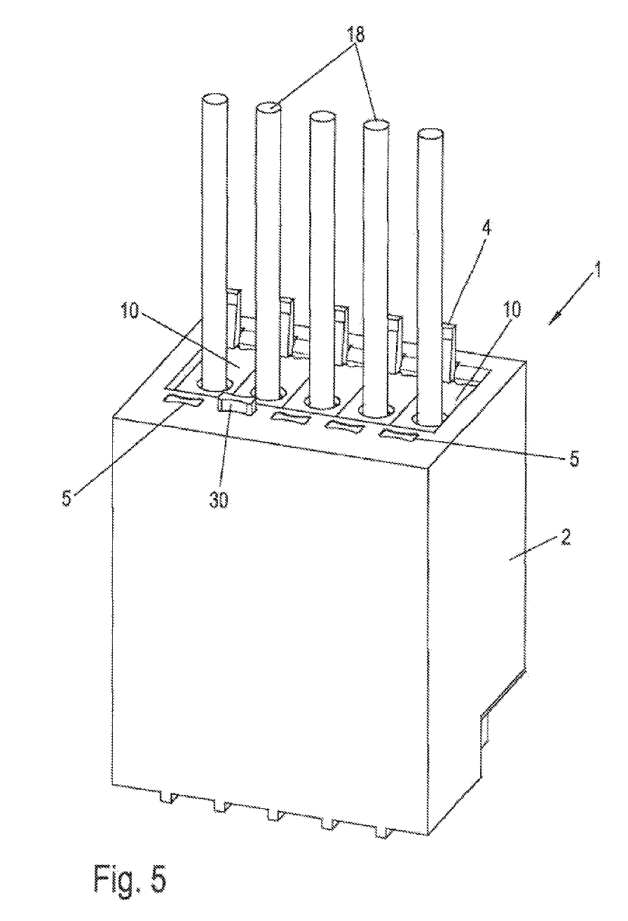

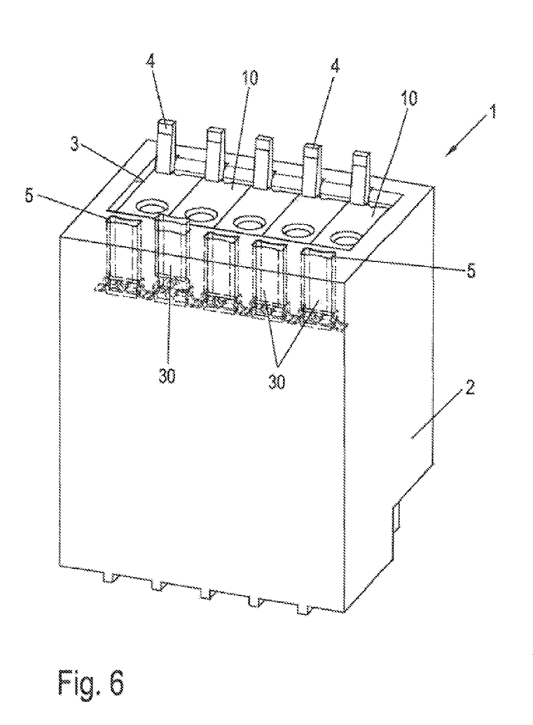

FIGS. 5 and 6 show another embodiment of a plug-in connector 1 with inserts 10. The plug-in connector 1 corresponds in its basic construction to the embodiment of FIG. 1, to which reference is expressly made.

In addition to the embodiment of FIG. 1, a receptacle 5 for an excess temperature warning element 30 is formed adjacent to each chamber 3 into which the inserts 10 are pushed in. The excess temperature warning element 30 is also designated in brief as warning element 30.

FIG. 5 shows the plug-in connector 1 with connected conductors 18. In FIG. 6 the conductors 18 are omitted for reasons of clarity. To this end, a part of the housing 2 of the plug-in connector 1 is shown in phantom so that the warning elements 30 arranged in the housing 2 can be seen.

The warning elements 30 detect an elevated temperature occurring in the area of the inserts, for example a temperature above 80° Celsius or above 100° Celsius, and provide an optical signal when such an elevated temperature is detected. In the base state, the warning elements 30 are arranged in the receptacle 5 in such a manner that they are positioned flush with the housing 2 or even lower relative to the housing 2. After the detection of an elevated temperature, a section of the warning element 30 appears opposite the housing 2 and therefore indicates the excess temperature detected. In the embodiment of FIGS. 5 and 6, this instance occurred from the left for the second warning element 30. The visible portion of the warning element 30 preferably has a different color than the housing 2 so that an occurrence of excess temperature can be rapidly detected.

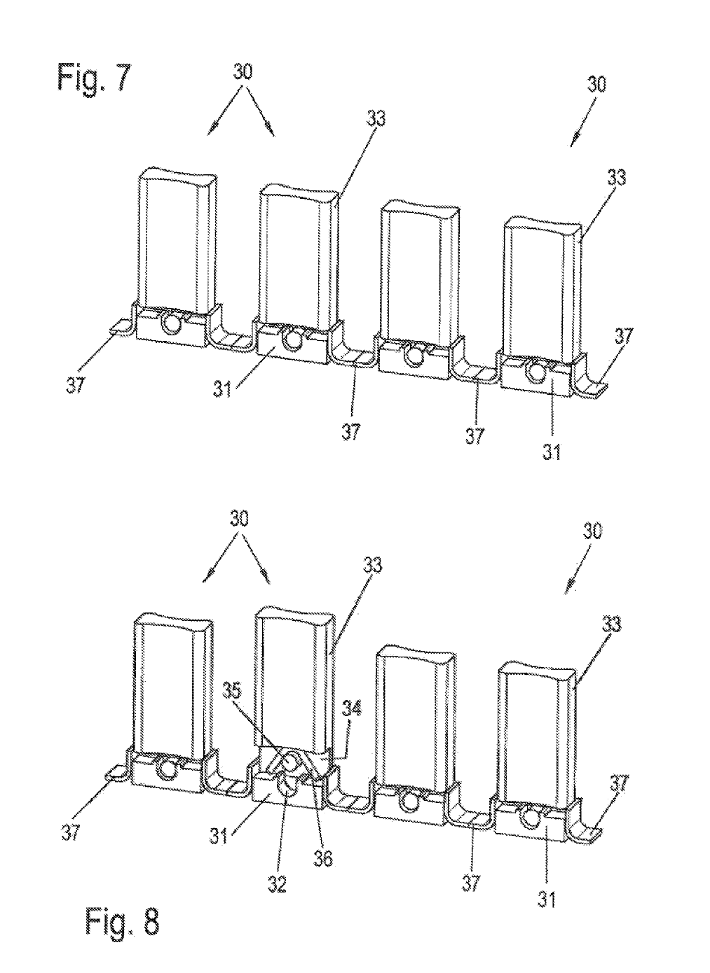

FIGS. 7 and 8 show four warning elements 30 lying adjacent to each other and insulated from the plug-in connector 1. In FIG. 7, all four warning elements 30 are in their base state, in contrast to the example of FIG. 8 in which the second warning element 30 from the left is in a released state.

The warning elements 30 have a base 31 which is substantially shaped like a parellelepiped with an upwardly open trough 32 in the central area. Furthermore, each warning element 30 includes a signal body 33 which has the shape of a flattened tongue in the lower area. The flattened section is indicated by the reference numeral 34.

In the receptacles 5 in the plug-in connector 1, the base 31 is either firmly received within or is integrally formed from the housing 2 of the plug-in connector. The signal body 33 can move up and down within certain limits relative to the base 31. A bolt 35 projects in the flattened section 34 and is located in the trough 32 of the base 31 when the signal body 33 is completely lowered.

A spring element 36 is clamped between the bolt 35 in the upper, non-flattened part of the signal body 33. The spring element 36 is formed of a so-called memory material which is a metallic alloy that “remembers” a certain impressed shape and re-assumes the shape from a current shape state after a thermal activation.

In the case of the warning element 30, the impressed shape is angular, as is represented in the case of the released warning element 30 (second from left in the FIGS. 7 and 8). This state can be brought into a metastable, current shape state in that the signal body 33 of the warning element 30 is pressed down to stretch the spring element 36. This stretched shape is retained until the spring element 36 is heated to a certain excess temperature set by the composition of the material.

In the warning elements 30 according to the invention, the spring element 36 is therefore a spring whose stored energy is utilized for the upward thrusting of the signal body 33 and also for the temperature-sensitive, releasing element.

The warning elements 30 can serve as optical indicators. In addition, the release of one of the warning elements 30 can also be readily detected electrically. To this end contact tongues 37 are arranged laterally on the base 31 of each warning element 30 and project upward slightly above the level of the base 31.

A stretched spring element 36 electrically connects the two contact tongues 37 positioned laterally on a base 31. A warning element 30 is released when the spring element 36 assumes the angular shape. In the angled state, the contact tongues 37 are not connected to each other by the spring element 36 which can be detected by an electronic evaluation device.

It is conceivable to separately evaluate each warning element 30 in this manner. In the arrangement of FIGS. 7 and 8, the warning elements 30 are electrically connected in series wherein facing contact tongues 37 of adjacent warning elements 30 are connected to each other or are constructed in one piece. The chain of warning elements 30 can be contacted and evaluated at the outer contact tongues 37 arranged to the left and the right of the chain. If one of the warning elements 30 is released, the series circuit of the warning elements 30 is interrupted.

The excess temperature warning elements 30 have been described above in conjunction with a plug-in connector 1 with inserts 10. It is understood that the excess temperature warning elements 30 can also be used in other types of plug-in connectors or other electrical or electronic devices.

1-8. (canceled)

9. A plug-in connector, comprising
(a) a housing containing at least two chambers;
(b) an insert adapted for insertion in each of said housing chambers, said insert including a conductor receptacle for receiving a conductor having an outer insulation layer and a plug-in contact that can be connected to the conductor without requiring a connecting tool.

10. A plug-in connector as defined in claim 9, said conductor receptacle includes at least one contact penetrating through said conductor insulation layer.

11. A plug-in connector as defined in claim 10, wherein said contact penetrating through said insulation layer comprises a fork-shaped cutting contact.

12. A plug-in connector as defined in claim 11, wherein the fork-shaped cutting contact is formed in one piece with said plug-in contact.

13. A plug-in connector as defined in claim 10, wherein said insert includes a bottom part and an upper part, said conductor being pressed by pivotal movement of said upper part relative to said bottom part into said contact penetrating through said conductor insulation layer.

14. A plug-in connector as defined in claim 9, wherein said conductor receptacle includes at least one traction spring.

15. A plug-in connector as defined in claim 9, and further comprising at least one excess temperature warning element connected with said housing which signals an excess temperature occurring on one of said inserts.

16. A plug-in connector as defined in claim 15, wherein said excess temperature warning element includes an element formed of a memory metal which deforms during the excess temperature to initiate signaling of the excess temperature.
